(19) United States
(12) Patent Application Publication
(10) Pub. No.: US 2005/0172830 A1
(43) Pub. Date: Aug. 11, 2005

(54) Support unit, particularly for a cooking device

(75) Inventors: Hubert Giraud, Stutensee-Fr (DE); Manfred Hintermayer, Karlsruhe (DE); Reinhard Wiedenmann, Weingarten (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/077,138

(22) Filed: Mar. 3, 2005

(30) Foreign Application Priority Data
Sep. 3, 2002 (DE) 10240627.8
Aug. 20, 2003 (WO) PCT/EP03/09241

(51) Int. Cl. B27B 3/12

(52) U.S. Cl. 99/448

(57) ABSTRACT

A support unit for a cooking appliance including at least one support means and at least one first means which receives a first support part of the support means and can be fastened to an inner wall of the cooking appliance. To provide a general support unit which allows tolerance compensation in a simple manner and which can be mounted and dismounted easily, the first receiving means is provided with at least one first receiving area for introducing the first support part in a first direction of introduction and a second receiving area into which the first support part can be moved after introduction into the first receiving means.

The invention relates to a support unit, especially for a cooking device, according to the preamble of claim 1.

A generic support unit for a cooking device is known from DE 100 54 954 A1. The support unit constructed as a withdrawal device comprises guides by which means a cooking shelf can be withdrawn from a cooking compartment. Further, the support device has locating connecting means for detachable affixing of the guides to a cooking compartment wall. The locating connecting means associated with the guide have two latch pairs arranged offset with respect to one another in the direction of withdrawal, each comprising two locating elements which correspond with one another, wherein one of the locating elements of each latch pair is undetachably connected to the guide and the other locating element is undetachably connected to the cooking compartment wall. The locating element arranged on the guide has a spherical locating head which can be engaged in a receiver of the locating element affixed to the cooking compartment wall with an engaging movement directed perpendicular to the cooking compartment wall.

The object of the invention is especially to provide a generic support unit with the facility for simply compensating for tolerance, which can be mounted and dismounted easily. The object is solved according to the invention by the features of claim 1, whilst advantageous embodiments and further developments of the invention can be deduced from the dependent claims and the alternative independent claims.

The invention relates to a support unit, especially for a cooking appliance, comprising at least one support means and at least one first receiving means for a first support part of the support means, which can be fastened to a wall.

It is proposed that the receiving means has at least one first receiving area for introducing the first support part in a direction of introduction and a second receiving area into which the first support part can be moved after being introduced.

As a result of the division into a first and a second receiving area, tolerances can advantageously be compensated and jamming during mounting and dismounting can be avoided. Basically it is feasible that the first support part is executed such that it can be tilted into the second receiving area and during an especially translatory displacement, however, tolerances can advantageously be compensated simply by means of a variable displacement path. Furthermore, an easy-to-clean support unit can be achieved.

Since the receiving means are executed as a component which can be affixed to the wall and are not formed by the wall itself, this can especially advantageously be designed for its function, any undesired negative influence of the wall can be at least largely avoided and ease of mounting and dismounting can be achieved over a long lifetime with a secure connection present after mounting. The receiving means can be formed of various materials which seem appropriate to the person skilled in the art, such as for example from metal, a heat-resistant plastic etc. Further, the support unit can be formed of suspended grids, telescopic systems etc.

If the direction of introduction is perpendicular to a direction of movement of the first support part in the second receiving area, easily understandable mounting and dismounting and in addition, an especially secure connection between the support means and the receiving means can be achieved.

The receiving areas can have different forms which seem appropriate to the person skilled in the art. However, receiving means and support means which are especially simple in design and inexpensive, can be achieved if the first and the second receiving area form a keyhole-shaped recess with a broad and a narrow area. Furthermore, largely self-explanatory mounting and dismounting can be achieved.

In a further embodiment of the invention, it is proposed that the first support part can be fixed in positive contact in the second receiving area opposite to the direction of introduction. Small mounting and dismounting forces can be achieved compared with pure force-locking securing in the second receiving area, which is also possible, and nevertheless, undesirable release of the first support part from the receiving means can be reliably prevented.

Form-locking fixing towards the direction of introduction can be simply achieved by the first support part having an area adapted to the second receiving area. If the first and the second receiving area form a keyhole-shaped recess with a broad and a narrow region, the first support part can be inexpensively adapted to the second receiving area by squeezing whereby existing systems can be modified simply and cheaply.

It is further proposed that the first receiving means can be fixed in the wall with a spring element, whereby the spring element can advantageously be mounted at least largely free from play in the wall as a result of force-locking without tight cost-intensive tolerances needing to be adhered to.

If, in addition, the first support part can be fixed in the first receiving means by means of a spring element, the first support part can further advantageously be fixed at least largely free from play in the receiving means and additional components, especially spring elements, assembly expenditure and costs can be saved.

If at least one second receiving means which can be mounted in the wall is provided, which has a first receiving area for introducing a second support part in a direction of introduction and a second receiving area into which the second support part can be moved after being introduced, an advantageously secure connection can be achieved by means of a special movement sequence of the support means with particularly small mounting and dismounting forces.

If the first and the second receiving means have the same design, the number of different components can be reduced and the costs lowered. If the first receiving means is arranged twisted compared to the second receiving means in the mounted state, the support means can advantageously be secured by the receiving means in different directions, parallel to the wall. The support means can preferably be secured in the horizontal direction in a front area and in the vertical direction in a rear area so that undesirable tipping of the support means during loading of the same can especially be avoided by the rear receiving means.

Further advantages are obtained from the following description of the drawings. Exemplary embodiments of the invention are shown in the drawings. The drawings, the description and the claims contain numerous features in combination. The person skilled in the art will more appropriately also consider the features individually and combine them to give appropriate further combinations.

In the figures:

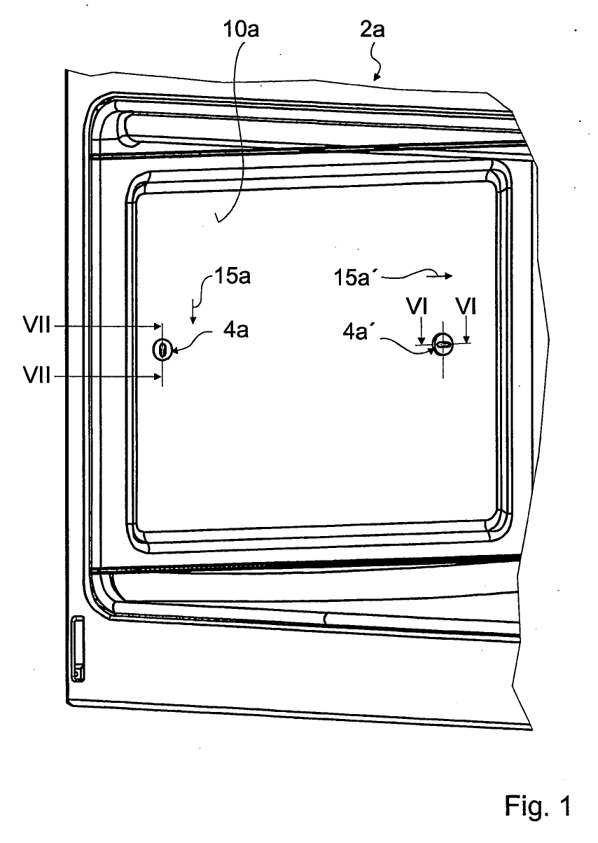

FIG. 1 is a section of a baking oven with a muffle bounding a cooking compartment and with two receiving means for a support unit,

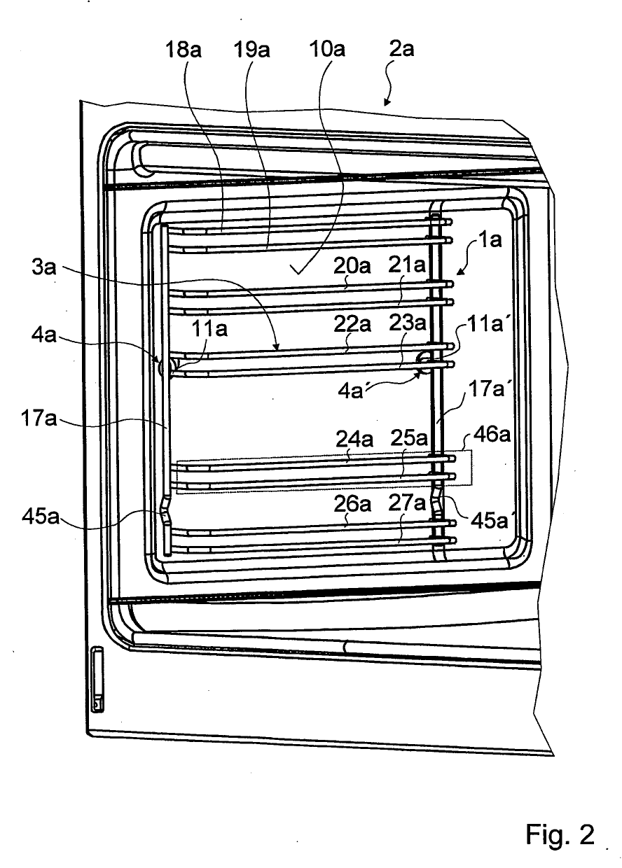

FIG. 2 is the baking oven from FIG. 1 with an assembled support means of the support unit,

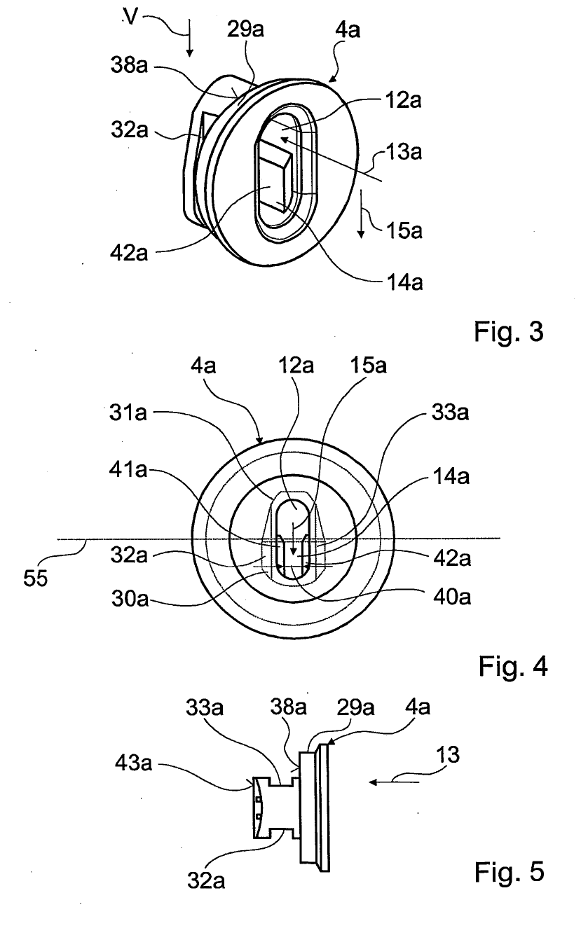

FIG. 3 is a receiving means from FIG. 1 viewed obliquely from the front,

FIG. 4 is the receiving means from FIG. 3 viewed from the front,

FIG. 5 is a view in the direction V in FIG. 3,

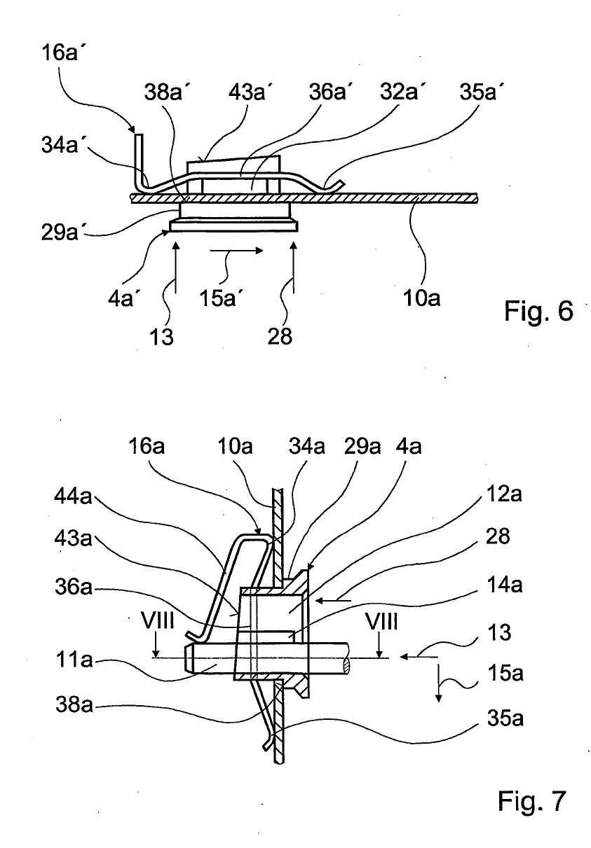

FIG. 6 is a section along the line VI-VI in FIG. 1 through a muffle wall,

FIG. 7 is a section along the line VII-VII in FIG. 1 with a support means,

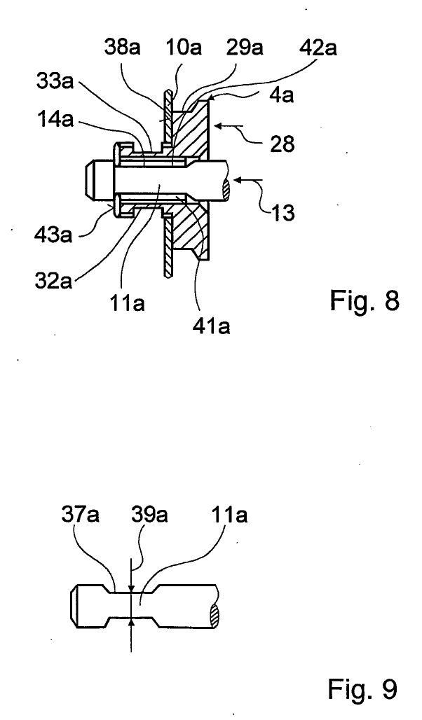

FIG. 8 is a section along the line VIII-VIII in FIG. 7,

FIG. 9 shows a support part of the support means from FIG. 2,

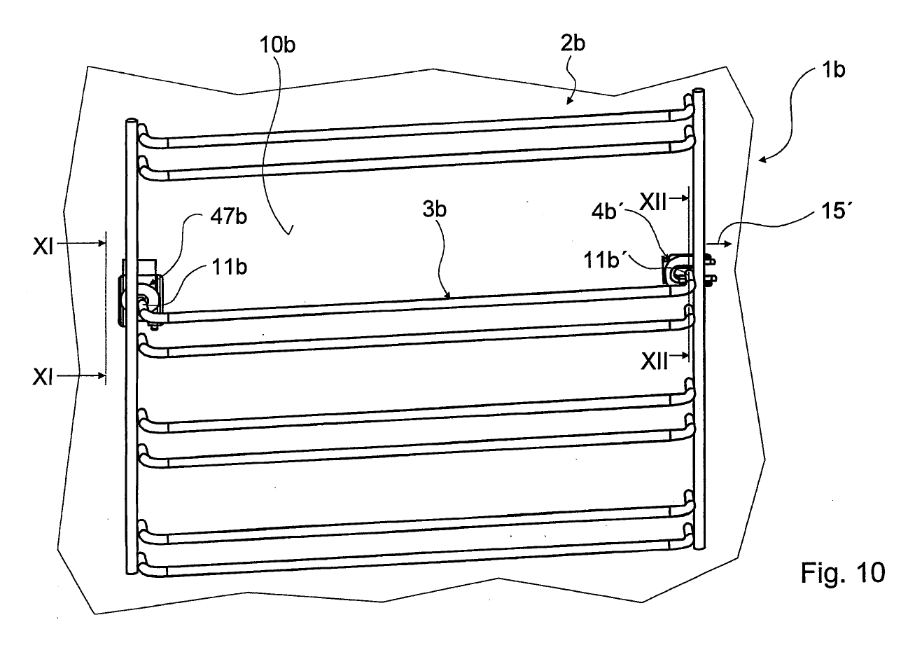

FIG. 10 shows a section of an alternative baking oven with an alternative support unit with two different receiving means,

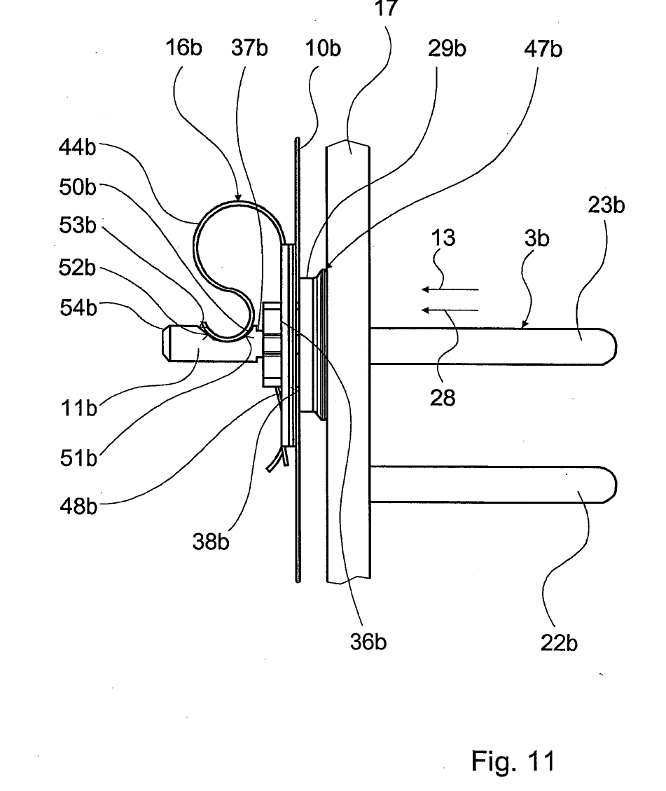

FIG. 11 is a section along the line XI-XI in FIG. 10,

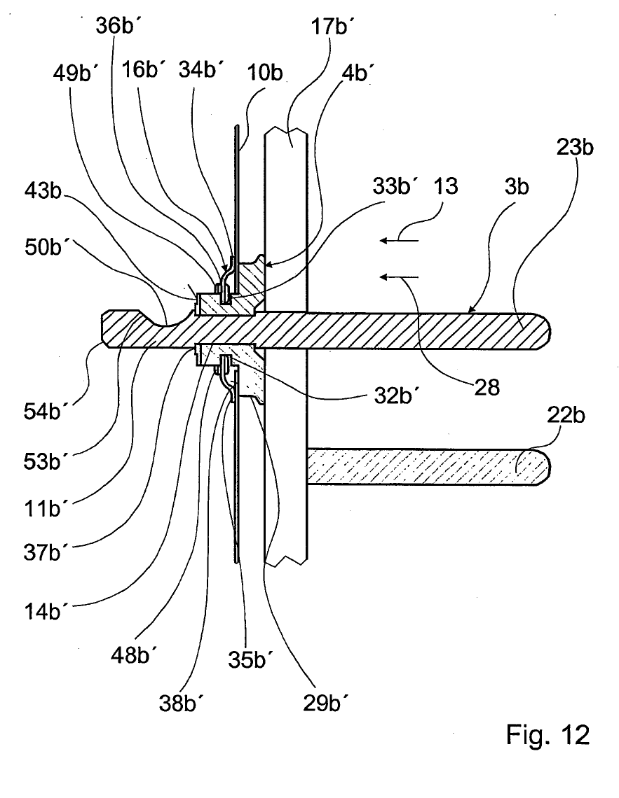

FIG. 12 is a section along the line XII-XII in FIG. 10,

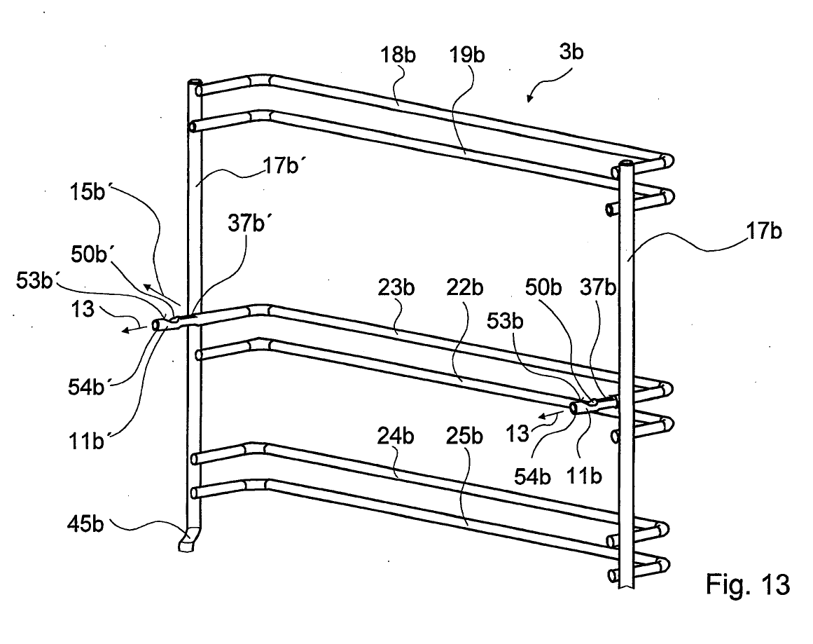

FIG. 13 is a support means with two support parts of the support unit from FIG. 10 and

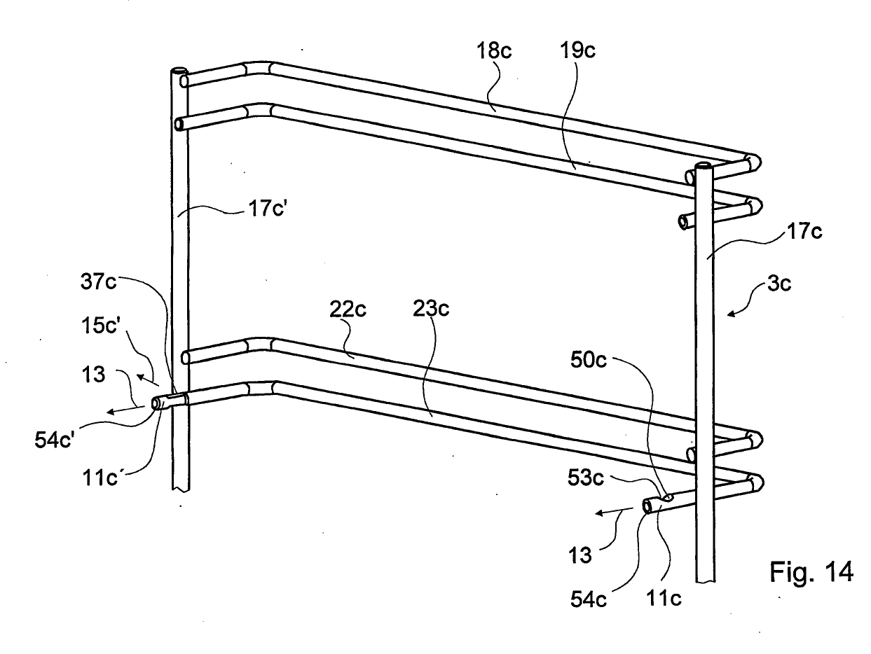

FIG. 14 is an alternative support means with two different support parts.

FIG. 1 shows a section of a baking oven 2a with a muffle bounding a cooking compartment. In side muffle walls 10a, first recesses are inserted at about half the height of the muffle in a front area and second recesses are inserted in a rear area at the same height. Receiving means 4a, 4a′ of a support unit 1a having the same design and constructed as sockets are mounted in the recesses, wherein in each case, the front receiving means 4a is mounted twisted with respect to the rear receiving means 4a′.

The support unit 1a comprises two support means 3a having the same design, wherein only one of the two is shown and described subsequently. The support means 3a is affixed to the muffle wall 10a with moulded-on support parts 11a, 11a′ by means of the receiving means 4a, 4a′ (FIG. 2). When considered in its position mounted on the muffle wall 10a, the support means 3a comprises front and a rear connecting rods 17a, 17a′, which run vertically and by which means ten guide rods 18a-27a′, which run horizontally are connected to form a unit. The guide rods 18a-27a each comprise a part region which extends perpendicular to the muffle wall 10a in the assembled state, between which a part region extending from the front region into the back region, is arranged parallel to the muffle wall 10a.

The part regions of the guide rods 18a-22a and 24a-27a extending perpendicular to the muffle wall 10a substantially end in one plane with a side of the connecting rods 17a, 17a′ facing the muffle wall 10a. Support parts 11a, 11a′ which extend perpendicular to the muffle wall 10a via the connecting rods 17a, 17a′ are moulded in one piece onto the guide rods 23a and are inserted in the receiving means 4a, 4a′ in the mounted state.

The receiving means 4a, which as already stated has the same design as the receiving means 4a′ and is described subsequently as an example for both receiving means 4a, 4a′, has a first region which points into the cooking compartment in the mounted state and a second region which extends through the muffle wall 10a with which, during mounting on the muffle wall 10a in the direction of mounting 28 which corresponds to the direction of introduction 13 of the support part 11a into the receiving means 4a, the receiving means 4a is inserted through the muffle wall 10a (FIG. 3 to 8). The first region, which has a cross-sectional area with a round outer contour, has a stepped outer contour in the longitudinal direction with a decreasing diameter in the mounting direction 28. The first region thus forms a groove-shaped receiving area 29a into which components, such as especially a catalytic sheet, can advantageously be mounted. When mounted, the first region abuts with a front side 38a facing away from the cooking compartment, against an inner side of the muffle wall 10a.

The second region of the receiving means 4a has a cross-sectional area which has a substantially rectangular outer contour in a first part region 30a, adjacent to which is a second part region 31a which has a tapered contour in the direction of a rounded end of the cross-sectional area. The recesses in the muffle wall 10a are correspondingly matched to the contours of the cross-sectional areas of the second regions of the receiving means 4a, 4a′ which are asymmetric with respect to a central axis 55a so that incorrect mounting of the receiving means 4a, 4a′ is reliably avoided.

Grooves 32a, 33a extending parallel to the muffle wall 10 when mounted are inserted in the second region on opposing sides. When the receiving means 4a, 4a′ are inserted into the recesses of the muffle wall 10a, these can be secured in the recesses free from play in a force- and form-locking fashion by means of one clip-like spring element 16a, 16a′ in each case. The spring elements 16a, 16a′ are inserted substantially parallel to the muffle wall 10a into the grooves 32a, 33a, 32a′, 33a′ on the side facing away from the cooking compartment. When inserted into the grooves 32a, 33a, 32a′, 33a′, the spring elements 16a, 16a′ are supported on the muffle wall 10a by means of opposing spring legs 34a, 35a, 34a′, 35a′ and act on the receiving means 4a, 4a′ with contact regions 36a, 36a′ in the grooves 32a, 33a, 32a′, 33a′ and pull these into the recesses of the muffle wall 10a.

Furthermore, the receiving means 4a has a first receiving area 12a for introducing the support part 11a in the direction of introduction 13 and a second receiving area 14a into which the support part 11a can be displaced in translatory fashion after being introduced, wherein the direction of introduction 13 is perpendicular to a direction of movement 15a of the support part 11a in the second receiving area 14a.

The first and the second receiving region 12a, 14a form a keyhole-shaped recess wherein the first receiving area 12a forms a broad region and the second receiving area 14a forms a narrow region of the keyhole-shaped recess (FIG. 4). The support parts 11a, 11a′ can each be fixed in a form-locking fashion in the second receiving area 14a, 14a′ towards and in the direction of introduction 13 whereby especially forces acting horizontally at the side on the support means 1a can advantageously be supported via the support parts 11a, 11a′ and via the receiving means 4a, 4a′ on the muffle wall 10a. For this purpose, the support parts 11a, 11a′ have a region 37a adapted to the second receiving area 14a, 14a′ by squeezing in each case shortly before their free end (FIG. 9). A remaining thickness 39a of the support part 11a in the area 37a substantially corresponds to a width 40a of the second receiving area 14a. The support parts 11a, 11a′ have the same design so that the support means 3a can be mounted both on a left side of the cooking compartment and on a right side of the cooking compartment. In the second receiving area 14a, 14a′ projections 41a, 42a pointing radially inwards into the recesses are moulded on, said projections having moulded-on introduction slopes in the direction of the first receiving area 12a, 12′ to make it possible to guide the support part 11a, 11a′ advantageously in each case from the first receiving area 12a, 12a′ into the second receiving area 14a, 14a′ without tilting.

In order to achieve that during mounting in the receiving means 4a, 4a′ or during displacement from the first receiving area 12a, 12a′ into the second receiving area 14a, 14a′, the support parts 11a, 11a′ are drawn into a mounting position at least largely free from play in the receiving means 4a, 4a′, on a side facing away from the cooking compartment the receiving means 4a, 4a′ each have a sloping front side 43a, 43a′ which has a positive slope starting from the first receiving area 12a, 12a′ in the direction of the second receiving area 14a, 14a′. During displacement of the support parts 11a, 11a′ from the first receiving area 12a, 12a′ into the second receiving area 14a, 14a′, the support parts 11a, 11a′ are pulled towards the projections 41a, 42a in each case with their edge of the region 37a, 37a′ formed by squeezing, which faces the cooking compartment (FIG. 8).

During mounting of the support means 3a on the muffle wall 10a the rear support part 11a′ is first inserted into the first receiving area 12a′ of the rear receiving means 4a′, which is arranged in the cooking compartment in front of the second receiving area 14a′, the first and the second receiving area 12a′, 14a′ being arranged horizontally one after the other (FIGS. 1, 6 and 7). The support part 11a′ is then displaced from the first receiving area 12a′ further back into the cooking compartment in the direction of movement 15a′ into the second receiving area 14a′. In particular, tolerances of the support means 3a and tolerances with regard to the position of the recesses in the muffle wall 10a can be compensated by a variable displacement path in the direction of movement 15a′.

When the support part 11a′ is guided into the second receiving area 14a′, the front support part 11a is inserted into the first receiving area 12a of the front receiving means 4a which is arranged in the cooking compartment above the second receiving area 14a, the first and the second receiving area 12a, 14a being arranged vertically above one another. The support part 11a is then displaced from the first receiving region 12 downward in the direction of movement 15a into the second receiving region 14a.

In order to avoid the front support part 11a being undesirably lifted out of the second receiving region 14a, a spring arm 44a is moulded in one piece onto the spring element 16a (FIG. 7), which is deflected upwards during insertion of the support part 11a into the first receiving area 12a and in the second receiving area 14a loads the support part 11a downwards in the direction away from the first receiving area 12a.

In the lower region above the lower two guide rods 26a, 27a in its connecting rods 17a, 17a′, the support means 3a has recesses 45a, 45a′ which point towards the muffle wall 10a when the support means 3a is mounted and form rounded contact surfaces which protect the muffle wall 10a. The recesses 45a, 45a′ have substantially the same height as the second region of the receiving means 4a, 4a′ projecting over the muffle wall 10a, so that an advantageous substantially perpendicular alignment of the connecting rods 17a, 17a′ is achieved. In the upper region the support means 3a is supported on the muffle wall 10a by means of the front sides of the part regions of the guide rods 19a running perpendicular to the muffle wall 10a, which substantially bridge a distance corresponding to the height of the second regions of the receiving means 4a, 4a′ between the connecting rods 17a, 17a′ and the muffle wall 10a. Instead of by means of the guide rods 17a, the support means 3a could also be supported in the upper region by means of recesses corresponding to the lower recesses 45a, 45a′. Since the contact forces in the upper region are generally lower compared to the lower region, recesses in the upper region can, however, basically be dispensed with. The guide rods 18a-27a can be used directly as contact surfaces for baking sheets or the like or they can serve to fix telescopic rails 46a, as is indicated in FIG. 2, or they can be replaced by telescopic rails 46a.

The dismounting sequence of the support means 3a is the reverse of the mounting and both mounting and dismounting can be carried out with one hand.

FIGS. 10 to 14 show further exemplary embodiments. In the alternative exemplary embodiments components which remain substantially the same in the description are basically numbered with the same reference numbers, the letters “a”, “b” and “c” being used to differentiate the exemplary embodiments. Furthermore, reference can be made to the exemplary embodiment in FIGS. 1 to 9 with regard to features and functions which remain the same. The following description is substantially restricted to differences from the exemplary embodiments in FIGS. 1 to 9.

FIG. 10 shows a section of an alternative baking oven 2b with a muffle bounding a cooking compartment and an alternative support unit 1b with two different receiving means 4b′, 47b. The rear receiving means 4b′ to receive a support part 11b′ of a support means 3b has substantially the same design as the receiving means 4a, 4a′ and has the same mounting position as the receiving means 4a′. The receiving means 4b′ is held in its mounting position with a clip-like spring element 16b′ which is inserted into grooves 32b′, 33b′ of the receiving means 4b′ (FIG. 12). In order to avoid the spring element 16b′ becoming undesirably released from the grooves 32b′, 33b′, locating lugs 48b′, 49b′ are moulded onto the spring element 16b′ which locate during insertion of the spring element 16b′ and grip behind the edges of the grooves 32b′, 33b′.

In contrast to the receiving means 4b′, the front receiving means 47b comprises only one receiving area into which a support part 11b of the support means 3b can be inserted (FIGS. 10 and 11). Otherwise, the receiving means 47b substantially corresponds to the receiving means 4b. The receiving means 47b is held in its mounting position using a clip-shaped spring element 16b which is inserted into grooves of the receiving means 47b not shown in detail. In this case, the spring element 16b is supported on a side of the muffle wall 10b facing away from the cooking compartment and acts via the edges of the grooves on the receiving means 47b in the direction away from the cooking compartment. In order to avoid the spring element 16b becoming undesirably released from the grooves, locating lugs 48b are moulded onto the spring element 16b, which locate during insertion of the spring element 16b and grip behind the edges of the grooves.

When considered in the mounted state, a perpendicularly aligned, S-shaped spring arm 44b is moulded onto the spring element 16b. When the support means 3b is inserted into the receiving means 47b with its support part 11b in the direction of introduction 13, the S-shaped spring arm 44b locates with its lower curved element into a recess 50b of the support part 11b having a substantially hemispherical longitudinal cross-section. In this case, the lower curved element of the S-shaped spring arm 44b forms an introduction slope 51a and a withdrawal slope 52b. The introduction slope 51b cooperates during location of the support part 11b in the receiving means 47b with a phase 54b of the support part 11b and the withdrawal slope 47b cooperates during disengagement of the support part 11b from the receiving means 47b with an oblique surface 53b which runs flat towards the free end of the support part 11b adjacent to the recess 50b to additionally facilitate simple location and disengagement when the support part 11b is held securely in the receiving means 47b. For disengagement the support means 3b can simply be pulled in the area of the support part 11b in the direction opposite to the direction of introduction.

Mounting of the support means 3b corresponds to that of the support means 3a of the support unit 1a except that the front support part 11b of the support means 3b must be inserted exclusively perpendicularly into the receiving means 47b. The support unit 1b according to FIGS. 10 to 13 is especially suitable for cooking appliances with extendable telescopic rails where the front receiving means 47b can reliably avoid undesirable lifting of the support means 3b from its mounting position and especially during closure of a baking oven door when the telescopic rails are extended.

The support parts 11b, 11b′ have the same design so that the support means 30 can be mounted on the left side of the cooking compartment and on the right side of the cooking compartment (FIG. 13). The oblique surface 53b, 53b′, the recess 50b, 50b′ and a region 37b, 37b′ formed by squeezing are in each case arranged one after the other starting from the free end of the support parts 11b, 11b′ in the longitudinal direction of the same.

FIG. 4 shows an alternative support means 3c with differing support parts 11c, 11c′ which can be mounted like the support means 3b in receiving means 47b and 4b. The front support part 11c has an oblique surface 53c and a recess 50c and no region formed by squeezing, and the rear support part 11c′ has a region 37c formed by squeezing and no oblique surface and no recess for a spring arm. When the receiving means 4b, 47b are correctly mounted, the support parts 11c, 11c′ only make it possible to mount the support means 3c on a left side in a cooking compartment whereby incorrect mounting can be avoided by means of the support parts 11c, 11c′ if the support means 3c is only intended for mounting on the left side, for example, if sloping contact planes are to be achieved by means of the guide rods 18c, 19c, 22c, 23c in the direction of introduction of a baking sheet.

### REFERENCE LIST

1 Support unit
2 Cooking appliance
3 Support means
4 Receiving means
10 Wall
11 Support part
12 Receiving area
13 Direction of introduction
14 Receiving area
15 Direction of movement
16 Spring element
17 Connecting rod
18 Guide rod
19 Guide rod
20 Guide rod
21 Guide rod
22 Guide rod
22 Guide rod
23 Guide rod
24 Guide rod
25 Guide rod
26 Guide rod
27 Guide rod
28 Mounting direction
29 Receiving area
30 Part region
31 Part region
32 Groove
33 Groove
34 Spring leg
35 Spring leg
36 Contact region
37 Region
38 Front side
39 Thickness
40 Width
41 Projection
42 Projection
43 Front side
44 Spring arm
45 Recess
46 Telescopic rail
47 Receiving means
48 Locating lug
49 Locating lug
50 Recess
51 Introduction slope
52 Withdrawal slope
53 Sloping surface
54 Phase
55 Central axis

1-14. (canceled)

15. A support unit for a cooking appliance, comprising:
at least one support means including a first support part;
at least one first receiving means for receiving said first support part;
said first receiving means can be fastened to a wall of the cooking appliance;
said first receiving means including at least one first receiving area for introducing said first support part in a first direction of introduction; and
said first receiving means including at least one second receiving area into which said first support part can be moved after introduction into said first receiving area.

16. The support unit according to claim 15, including said first support part can be displaced into said second receiving area.

17. The support unit according to claim 15, including said first direction of introduction of said first support part is substantially perpendicular to a direction of movement of said first support part into said second receiving area.

18. The support unit according to claim 15, including said first and second receiving areas from a keyhole-shaped recess with a broad first area and a narrow second area.

19. The support unit according to claim 15, including said first support part can be fixed in positive contact in said second receiving area toward first direction of introduction.

20. The support unit according to claim 19, including said first support part has an area and shape adapted to be received into said second receiving area.

21. The support unit according to claim 15, including said said first receiving means can be fixed in said wall of said cooking appliance by a spring element.

22. The support unit according to claim 15, including first support part can be fixed in said first receiving means by said spring element.

23. The support unit according to claim 15, including at least one second receiving means which can be fastened to said wall of said cooking appliance which has a first receiving area for introducing a second support part in a direction of introduction for receiving said second support part and a second receiving area into which said second support part can be moved after introduction into said first receiving area.

24. The support unit according to claim 23, including said first receiving means is oriented twisted compared to the orientation of said second receiving means fastened to said wall.

25. Receiving means for a cooking appliance, the cooking appliance including a support unit having at least one support means including a first support part, the receiving means comprising:
including at least one first receiving means for receiving the first support part of the support unit;
said first receiving means can be fastened to a wall of the cooking appliance;
said first receiving means including at least one first receiving area for introducing said first support part in a first direction of introduction; and
said first receiving means including at least one second receiving area into which said first support part can be moved after introduction into said first receiving area.

26. Support means for a support unit of a cooking appliance, the support means comprising:
a first support part;
at least one first receiving means for receiving said first support part;
said first receiving means can be fastened to a wall of the cooking appliance;
said first receiving means including at least one first receiving area for introducing said first support part in a first direction of introduction; and
said first receiving means including at least one second receiving area into which said first support part can be moved after introduction into said first receiving area.

27. A cooking appliance, comprising:
a support unit;
said support unit including at least one support means including a first support part;
said support unit including at least one first receiving means for receiving said first support part;
said first receiving means can be fastened to a wall of the cooking appliance;
said first receiving means including at least one first receiving area for introducing said first support part in a first direction of introduction; and
said first receiving means including at least one second receiving area into which said first support part can be moved after introduction into said first receiving area.
